(19) United States
(12) Patent Application Publication
(10) Pub. No.: US 2008/0068459 A1
(43) Pub. Date: Mar. 20, 2008

(54) APPARATUS AND METHOD FOR CONTROLLING VIDEO SURVEILLANCE SYSTEM

(75) Inventors: SHIH-FANG WONG, Tu-Cheng (TW); TSUNG-JEN CHUANG, Tu-Cheng (TW); JIANG-FENG SHAN, Shenzhen (CN); JIAN-GUO ZHU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/733,209

(22) Filed: Apr. 10, 2007

(30) Foreign Application Priority Data
Sep. 14, 2006 (CN) 200610200872.8

(51) Int. Cl. H04N 7/18; H04N 5/33

(52) U.S. Cl. 348/143; 348/164

(57) ABSTRACT

A video surveillance system includes a video camera, a display device, and a control apparatus. The video camera is used for capturing video images. The display device is used for displaying the video images. The control apparatus is used for controlling the video camera. The control apparatus includes a detector and a processing module. The detector is used for detecting an event and generating an event detected signal corresponding to the event. The processing module is used for enabling the video camera based on the event detected signal.

### BACKGROUND OF THE INVENTION

1. Field of the Invention

The present invention generally relates to a surveillance system and, more particularly, to an apparatus and method for controlling the surveillance system.

2. Description of Related Art

Video surveillance systems are widely used in a variety of places for securities, such as banks, airports, and supermarkets. Generally, a video surveillance system includes a camera for capturing video images of a monitored area. The video images are transmitted and displayed on cathode-ray tube (CRT) or liquid crystal display (LCD) monitors so as to allow users to remotely monitor the places.

Traditionally, the video surveillance system is enabled/disabled manually. In order to prevent a failure of capturing critical video images, all of the video images are transmitted and displayed on the monitors. However, unnecessary video images are captured although the monitored area is static or nothing abnormal is happening at the monitored area.

Therefore, an improved apparatus and method for controlling the video surveillance system is desired.

### SUMMARY OF THE INVENTION

A video surveillance system includes a video camera, a display device, and a control apparatus. The video camera is used for capturing video images. The display device is used for displaying the video images. The control apparatus is used for controlling the video camera. The control apparatus includes a detector and a processing module. The detector is used for detecting an event and generating an event detected signal corresponding to the event. The processing module is used for enabling the video camera according to the event detected signal.

A control apparatus includes a detector and a processing module. The detector is used for detecting an event and generating an event detected signal corresponding to the event. The processing module is used for enabling the video camera based on the event detected signal. The processing module includes a memory unit, a comparing unit, and a switching unit. The memory unit is used for storing a predetermined value. The comparing unit is used for comparing the predetermined value with the event detected signal. The switching unit is used for enabling the video camera based on a comparison result of the comparing unit.

A method for controlling a video surveillance system includes steps of: generating an event detected signal in response to an event; comparing the event detected signal with a predetermined value and generating a comparison result; and enabling a video camera if the event detected signal is larger than the predetermined value.

Other advantages and novel features will become more apparent from the following detailed description of preferred embodiments when taken in conjunction with the accompanying drawings, in which:

### BRIEF DESCRIPTION OF THE DRAWINGS

Many aspects of the apparatus and method for controlling the video surveillance system can be better understood with reference to the following drawings. The components in the drawings are not necessarily to scale, the emphasis instead being placed upon clearly illustrating the principles of the present system. Moreover, in the drawings, like reference numerals designate corresponding parts throughout the several views.

FIG. 1 is a block diagram of a video surveillance system in accordance with an exemplary embodiment, the video surveillance system includes a control apparatus;

FIG. 2 is a block diagram of the control apparatus of FIG. 1; and

FIG. 3 is a flow chart illustrating a procedure of method for controlling the video surveillance system of FIG. 1 in accordance with an exemplary embodiment.

### DETAILED DESCRIPTION OF THE INVENTION

Reference will now be made to the drawings to describe a preferred embodiment of the present apparatus and method for controlling the video surveillance system, in detail.

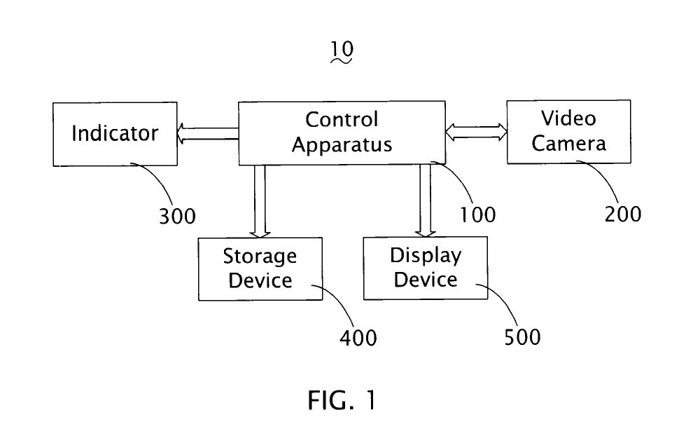

Referring to FIG. 1, a block diagram of a video surveillance system 10 in accordance with an exemplary embodiment is illustrated. The video surveillance system 10 includes a control apparatus 100, a video camera 200, an indicator 300, a storage device 400, and a display device 500.

The control apparatus 100 is used for enabling and/or disabling the video camera 200, and the indicator 300. When the video camera 200 is enabled, the control apparatus 100 processes video images captured by the video camera 200 and sends the video images to the storage device 400 and the display device 500 for storage and display respectively.

The video camera 200 is coupled to the control apparatus 100 and configured for capturing the video images. Preferably, the video camera 200 is capable of capturing the video images even if there is insufficient visible light to see an object through the naked eye. The video camera 200 can be, for example, but not limited to, an infrared video camera.

The indicator 300 is connected to the control apparatus 100 and configured for indicating whether the video camera 200 is capturing the video images. Exemplarily, the indicator 300 can be selected from a group consisting of a low emitting diode (LED) and a speaker.

The storage device 400 is coupled to the control apparatus 100 for storing the video images captured by the video camera 200. Typically, the storage device 40 is a hard disk drive. Furthermore, a tape drive or an optical disc drive can also be employed to store the video images.

The display device 500 is coupled to the control apparatus 100 and configured for displaying the video images. The video images captured by the video camera 200 are transmitted to and processed by the control apparatus 100. After processing, the video images are transmitted to the display device 500. Thus, the video images of a monitored area can be monitored remotely via the display device 500.

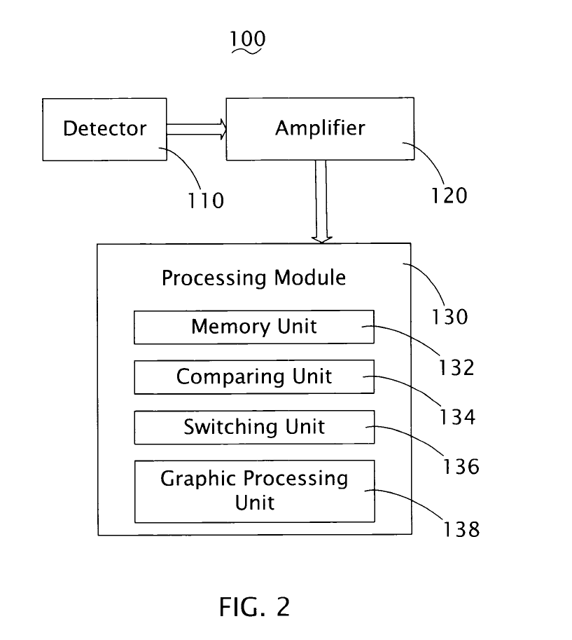

Referring also to FIG. 2, the control apparatus 100 includes a detector 110, an amplifier 120, and a processing module 130. The detector 110 is used for detecting an event and for generating an event detected signal corresponding to the event. If the event happens, for example, a person enters the monitored area; the detector 110 generates the event detected signal. Preferably, the detector 110 is an infrared sensor. The infrared sensor is capable of detecting an infrared emitting source, such as a human body. After detecting the infrared emitting source, the infrared sensor generates the event detected signal for enabling the video camera 200 to capture the video images. It is noted that the detector 110 may be other sensitive elements, for example, but not limited to, an acoustics sensor etc.

Generally, a power of the event detected signal generated by the detector 110 is relatively low. The amplifier 120 is coupled to the detector 110 and configured for amplifying the event detected signal and for transmitting the event detected signals amplified to the processing module 130.

The processing module 130 includes a memory unit 132, a comparing unit 134, a switching unit 136, and a graphic processing unit 138. The memory unit 132 is used for storing a predetermined value. The memory unit 132 can be a Read Only Memory (ROM) or other equivalents. The comparing unit 134 compares the predetermined value with the amplified event detected signal. If the amplified event detected signal is larger than the predetermined value, the comparing unit 134 sends an alert signal to the switching unit 136 and the indicator 300. After receiving the alert signal, the indicator 300 is enabled to indicate the event in the monitored area, for example, the LED emits lights or the speaker produces a sound. Furthermore, the switching unit 136 enables the video camera 200 to start capturing the video images after receiving the alert signal. The graphic processing unit 138 is used for receiving and processing the video images. For example, the graphic processing unit 138 codes and compresses the video images using a MPEG standard. Therefore, the video images having been coded and compressed can be stored in the storage device 400 without occupying too much capacity of the storage device.

When the person enters the monitored area by the video camera 200, the event detected signal is generated by the detector 110 and transmitted to the processing module 130. Then, the video camera 200 captures the video images. That is, the video surveillance system 10 is enabled automatically to capture the video images when the event happens.

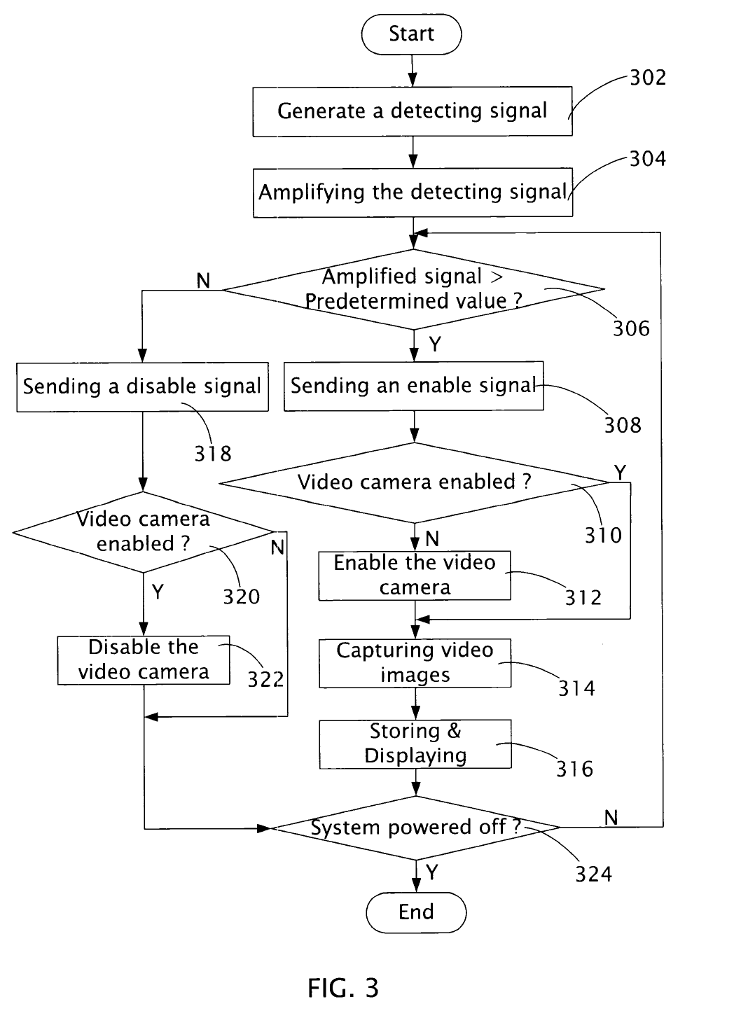

Referring to FIG. 3, an exemplary method for controlling the video surveillance system 10 is illustrated. First, in step 302, the detector 110 generates the event detected signal in response to the event. For example, the infrared sensor detects infrared radiations from the monitored area of the video surveillance system 10.

Then in step 304, the amplifier 120 amplifies the event detected signal and transmits the amplified event detected signal to the processing module 130.

In step 306, the comparing unit 134 compares the amplified event detected signal with the predetermined value. If the amplified event detected signal is larger than the predetermined value, the procedure proceeds to step 308.

In step 308, the switching unit 136 sends an enable signal to the video camera 200.

In step 310, a determination is made as to whether the video camera 200 is enabled. If the video camera 200 is already enabled, the procedure goes directly to step 314. If the video camera 200 is disabled, the procedure goes to step 312.

In step 312, the video camera 200 is enabled.

In step 314, the video camera 200 captures the video images and transmits the video images to the control apparatus 100.

In step 316, the control apparatus 100 receives and processes the video images. The video images processed are stored in the storage device 400 and/or displayed on the display device 500. After step 316, the procedure goes to step 324.

If the amplified event detected signal is smaller than the predetermined value in step 306, the procedure goes to step 318. In step 318, the switching unit 136 sends a disable signal to the video camera 200.

In step 320, it is detected whether the video camera 200 is enabled. If the video camera 200 is disabled, the procedure process straightly to step 324. If the video camera 200 is enabled, the procedure process to step 322.

In step 322, the video camera 200 is disabled.

In step 324, a determination is made as to whether the video surveillance system 10 is disabled. If so, the procedure is terminated. If the video surveillance system 10 is not disabled, the procedure goes back to step 306.

When the person enters the monitored area, the event detected signal is generated by the detector 110, amplified by the amplifier 120, and transmitted to the processing module 130. Therefore, the video camera 200 is enabled to capture the video images. That is, the method is able to automatically controls the video surveillance system 10 to capture the video images when something abnormal is happening.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A video surveillance system, comprising:
a video camera for capturing video images;
a display device for displaying the video images; and
a control apparatus for controlling the video camera, wherein the control apparatus comprising:
a detector for detecting an event and generating an event detected signal corresponding to the event; and
a processing module for enabling the video camera according to the event detected signal.

2. The video surveillance system as claimed in claim 1, further comprising a storage device for storing the video images.

3. The video surveillance system as claimed in claim 1, further comprising an indicator for indicating whether the video camera is capturing video images.

4. The video surveillance system as claimed in claim 1, wherein the detector is an infrared sensor.

5. The video surveillance system as claimed in claim 1, wherein the control apparatus comprises an amplifier for amplifying the event detected signal.

6. The video surveillance system as claimed in claim 5, wherein the processing module comprises a memory unit for storing a predetermined value.

7. The video surveillance system as claimed in claim 6, wherein the processing module further comprises a comparing unit for comparing the predetermined value with the amplified event detected signal.

8. The video surveillance system as claimed in claim 7, wherein the processing module further comprises a switching unit for enabling and disabling the video camera based on a comparison result of the comparing unit.

9. The video surveillance system as claimed in claim 8, wherein the switching unit enables the video camera if the amplified event detected signal is larger than the predetermined value.

10. The video surveillance system as claimed in claim 8, wherein the switching unit disables the video camera if the amplified event detected signal is smaller than the predetermined value.

11. The video surveillance system as claimed in claim 1, wherein the processing module comprises a graphic processing unit for compressing the video images.

12. A control apparatus for controlling a video camera, comprising:
a detector for detecting an event and generating an event detected signal corresponding to the event; and
a processing module for enabling the video camera according to the event detected signal, wherein the processing module comprising:
a memory unit for storing a predetermined value;
a comparing unit for comparing the predetermined value with the event detected signal; and
a switching unit for enabling the video camera based on a comparison result of the comparing unit.

13. The control apparatus as claimed in claim 12, wherein the switching unit enables the video camera if the event detected signal is larger than the predetermined value.

14. The control apparatus as claimed in claim 12, wherein the switching unit disables the video camera if the event detected signal is smaller than the predetermined value.

15. The control apparatus as claimed in claim 12, wherein the processing module comprises a graphic processing unit for compressing the video images.

16. The control apparatus as claimed in claim 12, further comprises an amplifier for amplifying the event detected signal.

17. A method for controlling a video surveillance system, comprising:
generating an event detected signal in response to an event;
comparing the event detected signal with a predetermined value and generating a comparison result; and
enabling a video camera if the event detected signal is larger than the predetermined value.

18. The method as claimed in claim 17, further comprising: disabling the video camera if the event detected signal is smaller than the predetermined value.

19. The method as claimed in claim 17, further comprising: amplifying the event detected signal.

20. The method as claimed in claim 17, further comprising: compressing and storing the video images.
